(19) United States
(12) Patent Application Publication
(10) Pub. No.: US 2026/0187121 A1
(43) Pub. Date: Jul. 2, 2026

(54) HOST DEVICE AND COMPUTATIONAL STORAGE SYSTEM INCLUDING THE SAME

(71) Applicant: SAMSUNG ELECTRONICS CO., LTD., Suwon-si (KR)

(72) Inventors: Myoungsoo JUNG, Daejeon (KR); Seungkwan KANG, Daejeon (KR); Hyungseok KO, Daejeon (KR); Heemin KIM, Daejeon (KR)

(73) Assignee: SAMSUNG ELECTRONICS CO., LTD., Suwon-si (KR)

(21) Appl. No.: 19/305,014

(22) Filed: Aug. 20, 2025

(30) Foreign Application Priority Data
Oct. 28, 2024 (KR) 10-2024-0149077

(51) Int. Cl. G06F 16/334; G06F 16/35; G06F 40/284

(52) U.S. Cl. CPC G06F 16/3344; G06F 16/35; G06F 40/284

(57) ABSTRACT

The present disclosure is related to a computational storage system, including a host processor and a plurality of computational storage devices. The host processor is configured to, based on a plurality of subsets included in a corpus, generate a plurality of embedding vectors associated with the plurality of subsets; based on distances between the plurality of embedding vectors, determine respective storage locations for respective subsets from the plurality of subsets from among the plurality of the computational storage devices; and based on the respective storage locations, transmit each of the plurality of subsets to one or more of the plurality of computational storage devices. A first computational storage device is configured to perform a first inference operation that outputs a first response associated with a user query, based on the first subset stored in the first computational storage device and the user query.

### CROSS-REFERENCE TO RELATED APPLICATION

The present application claims priority to Korean Patent Application No. 10-2024-0149077, filed on October 28, 2024, the entire contents of which are incorporated herein for all purposes by this reference.

### BACKGROUND

### Field

The present disclosure relates to a host device for performing an inference operation using a language model and a computational storage system including the same.

### Description of Related Art

A generative language model is an artificial intelligence (AI) technology that generates new texts based on input text data. The generative language model may be trained on a large amount of text data and automatically generate texts that fit various topics or styles. The language model is mostly used in the field of natural language processing and used in various application fields such as machine translation, text summarization, conversational AI, etc. The language model is also widely used to process complex language structures or unstructured data.

Data input into a language model may be processed in a multilayer network of the language model through an inference operation. Text responses in various forms may be generated through the inference operation of the language model.

### SUMMARY

The present disclosure aims to provide a host device for accelerating an inference operation of a language model and a computational storage system including the same.

The problem to be solved is not limited to the above, but the other tasks not mentioned above may be explicitly known to those skilled in the art from the description of the present disclosure below.

According to embodiments, there is provided a computational storage system, including a host processor, and a plurality of computational storage devices including a first computational storage device, and configured to communicate with the host processor, wherein the host processor is configured to, based on a plurality of subsets included in a corpus, generate a plurality of embedding vectors associated with the plurality of subsets, the plurality of subsets comprising a first subset and a second subset; based on distances between the plurality of embedding vectors, determine respective storage locations for respective subsets from the plurality of subsets, wherein the respective storage locations are from among the plurality of the computational storage devices; and based on the respective storage locations, transmit each of the plurality of subsets to one or more of the plurality of computational storage devices. In embodiments, the first computational storage device is configured to perform a first inference operation that outputs a first response associated with a user query, based on the first subset stored in the first computational storage device and the user query.

According to embodiments, there is provided a computational storage system, including a host processor, and a plurality of computational storage devices including a first computational storage device and a second computational storage device, and configured to communicate with the host processor. The host processor is configured to generate a plurality of embedding vectors associated with the plurality of subsets based on a plurality of subsets included in a corpus; categorize the plurality of subsets into a plurality of subset groups; categorize subsets associated with a predetermined number of embedding vectors within a predetermined order from one embedding vector of the plurality of embedding vectors as one subset group of the plurality of subset groups; categorize the subset corresponding to the one embedding vector into another subset group different from the one subset group; transmit each of the plurality of subset groups to one or more of the plurality of computational storage devices; and determine a subset associated with a user query among the plurality of subsets. In embodiments, the subset associated with the user query comprises a first subset stored in the first computational storage and a second subset stored in the second computational storage; the second computational storage device is configured to perform a second inference operation that outputs a second response associated with the user query based on the user query and the second subset; and at least part of the first inference operation and at least part of the second inference operation are performed in parallel.

According to embodiments, there is provided a host device including a host processor, and a host memory connected to the host processor, wherein the host processor is configured to generate a plurality of embedding vectors associated with the plurality of subsets based on a plurality of subsets included in a corpus, the plurality of subsets comprising a first subset and a second subset; based on distances between the plurality of embedding vectors, determine respective storage locations for respective subsets from the plurality of subsets, wherein the respective storage locations are among a plurality of computational storage devices that communicate with the host processor; and transmit each of the plurality of subsets to one or more of the plurality of computational storage devices based on the determined storage locations.

### BRIEF DESCRIPTION OF DRAWINGS

FIG. 1 illustrates an exemplary computational storage system according to embodiments of the present disclosure;

FIG. 2 illustrates an exemplary host processor of a computational storage system according to embodiments of the present disclosure;

FIG. 3 illustrates an exemplary internal configuration of a computational storage system according to embodiments of the present disclosure;

FIG. 4 illustrates an exemplary internal configuration of an accelerator of FIG. 3;

FIG. 5 illustrates an example where a computational storage device operates according to a request of a host processor according to embodiments of the present disclosure;

FIG. 6 is a flowchart illustrating an operation method of a computational storage system according to embodiments of the present disclosure;

FIG. 7 illustrates an embodiment of operation S620 of FIG. 6;

FIG. 8 illustrates an example conversion of a plurality of embedding vectors from a plurality of subsets in a space of an embedding vector;

FIG. 9 illustrates an embodiment of a grouping of a plurality of embedding vectors;

FIG. 10 illustrates an example in which a plurality of subset groups are stored in a computational storage device group;

FIG. 11 illustrates an example in which a plurality of subset groups of FIG. 9 is stored in a computational storage device group;

FIG. 12 illustrates an example in which a plurality of subsets are stored in a plurality of computational storage devices according to another embodiment of the present disclosure;

FIG. 13 illustrates an example of grouping a plurality of subsets according to embodiments of the present disclosure;

FIG. 14 illustrates an example of grouping a plurality of subsets according to another embodiment of the present disclosure;

FIG. 15 illustrates an example of a table related to a storage position of each of a plurality of subsets;

FIG. 16 is a flowchart associated with an embodiment of operation S630 of FIG. 6 in detail;

FIG. 17 illustrates an embodiment of tokenization and an embedding look-up operation of operation S1660 of FIG. 16;

FIG. 18 illustrates an embodiment of a plurality of embedding vectors generated according to a plurality of tokenization and an embedding look-up operation;

FIG. 19 illustrates an embodiment of a relationship table representing a relationship between an address and an identifier in operation S1690 of FIG. 16;

FIG. 20 illustrates an embodiment of operation S640 of FIG. 6;

FIG. 21 and FIG. 22 are illustrate embodiments of operation S650 of FIG. 6 in detail;

FIG. 23 illustrate an embodiment of a plurality of inference operations being performed in parallel in an accelerator;

FIG. 24 illustrates an example of determining a final response based on a local response;

FIG. 25 illustrates an embodiment of operation S660 of FIG. 6; and

FIG. 26 illustrates an embodiment of operation S660 of FIG. 6.

### DETAILED DESCRIPTION

According to embodiments, the subsets similar to each other to be likely processed together may be transmitted to different computational storage devices, thereby increasing the amount of parallel processing between a plurality of computational storage devices.

According to embodiments of the present disclosure, each of the plurality of subset groups may be transmitted to more than two computational storage devices among the plurality of computational storage devices, thereby increasing the amount of parallel processing of the plurality of computational storage devices.

According to embodiments, subsets may be preprocessed in a pre-runtime so that an inference operation of the language model in a runtime may be accelerated.

According to embodiments, embedding conversion on a subset for retrieval augmented generation may not be performed in an inference operation, but an embedding vector converted from a subset before an inference operation (i.e., before a runtime) may be used in the inference operation of the language model, thereby accelerating the inference operation such as reducing time to first token (TTFT), and effectively preventing the overhead of the accelerator.

According to embodiments, the quality of the response of the language model may be enhanced and the hallucination of the language model may be reduced.

The various beneficial effects obtained from the present disclosure are not limited to the above, and may be easily understood in the description of specific embodiments of the present disclosure below.

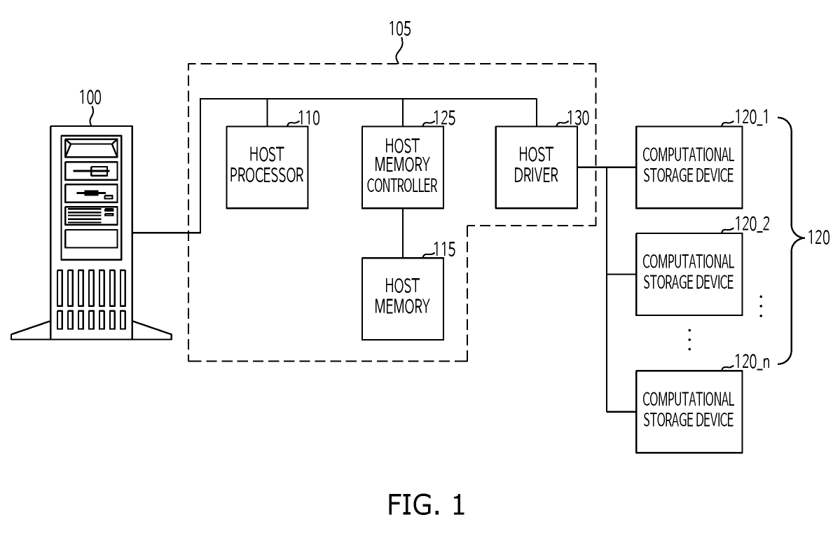

Referring to FIG. 1 to FIG. 26, the various embodiments of the present disclosure will be described below. The same reference numerals throughout the specification and the drawings may refer to the same components.

In the present disclosure, ‘each of the plurality of As’ may refer to each of all components included in the plurality of As, or may refer to each of part of the components included in the plurality of As. For example, each of the plurality of computational storage devices may refer to each of all the computational storage devices included in the plurality of computational storage devices, or may refer to each of part of the computational storage devices included in the plurality of computational storage devices.

FIG. 1 is a view illustrated to explain a computational storage system 100 according to embodiments of the present disclosure. The computational storage system may include a host device 105 and a computational storage device group 120. The computational storage device group 120 may include a plurality of computational storage devices 120_1 to 120_n (where n is a natural number of 2 or greater). In FIG. 1, for convenience of explanation, the host device 105 and the computational storage device group 120 are illustrated as being located outside the computational storage system 100, but the host device 105 and the computational storage device group 120 may be included inside the computational storage system 100.

The host device 105 may include a host processor 110, a host memory 115, a host memory controller 125, and a host driver 130. The host processor 110 may control the overall operation of the host device 105. For example, the host processor 110 may be implemented as a central processing unit (CPU), an application processor (AP), a graphic processing unit (GPU), a neural processing unit (NPU), a field-programmable gate array (FPGA), or at least one of various processing units including a microprocessor. In addition, the host processor 110 may be implemented as a system-on-a-chip (SoC).

The host processor 110 may include a single processor or any number of processors. The host processor 110 may include a reduced instruction set computer (RISC) architecture, a complex instruction set computer (CISC) architecture, or a combination thereof. The host processor 110 may be a single core processor or a multi-core processor.

The host processor 110 may be connected to the host memory 115. The host memory 115 may store data, commands, or programs required for the operation of the host processor 110. In various embodiments, the host memory 115 may be used for storing short-term data. The short term data may refer to data that is not expected to be stored for a long term. The examples of the short-term data may include a temporary file, cache, and others.

The host processor 110 and the host memory 115 may support an operating system that can execute various applications. An application may generate a read request or a write request for the host memory 115. A host memory controller 125 may manage data transmission between the host processor 110 and the host memory 115 based on the requests generated by applications.

The host processor 110 may communicate with a plurality of computational storage devices 120_1 to 120_n in the computational storage device group 120. The host processor 110 may communicate through a host driver 130. The host device 105 (or the host processor 110) and the plurality of computational storage devices 120_1 to 120_n may communicate using the Peripheral Component Interconnect express (PCIe) protocol, but the present disclosure is not limited thereto. For example, the host processor 110 and the plurality of computational storage devices 120_1 to 120_n may communicate using various protocols such as Non-Volatile Memory Express (NVMe), NVMe over Fabrics (NVMe-oF), Remote Direct Memory Access (RDMA), Transmission Control Protocol/Internet Protocol (TCP/IP), Universal Flash Storage (UFS), embedded MultiMediaCard (eMMC), InfiniBand, Serial Attached Small Computer System Interface (SAS, SCSI), Internet SCSI (iSCSI), Serial AT Attachment (SATA), etc.

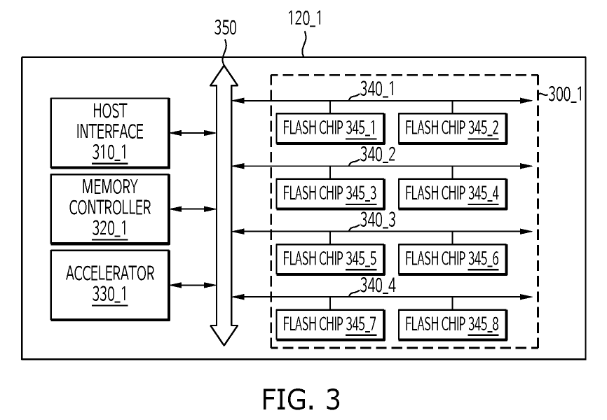

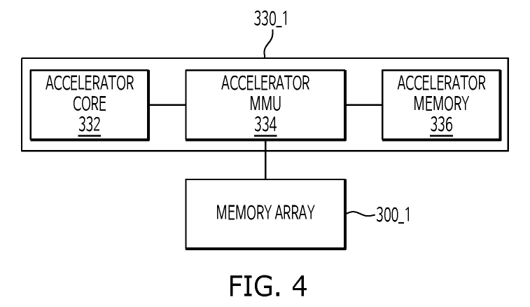

Each of the plurality of computational storage devices 120_1 to 120_n in the computational storage device group 120 may be a device that provides a computational service and/or a data storage service. Each of the plurality of computational storage devices 120_1 to 120_n may include a solid state drive (SSD), a hard disk drive (HDD), a solid state hybrid drive (SSHD), etc. The internal configuration of each of the plurality of computational storage devices 120_1 to 120_n will be described in detail below with reference to FIG. 3 and FIG. 4. Each of the plurality of computational storage devices 120_1 to 120_n in the computational storage device group 120 may perform tasks independently and/or in parallel. For example, each of a first computational storage device 120_1 and a second computational storage device 120_2 may perform different read operations, write operations, and/or inference operations using a hardware accelerator in parallel.

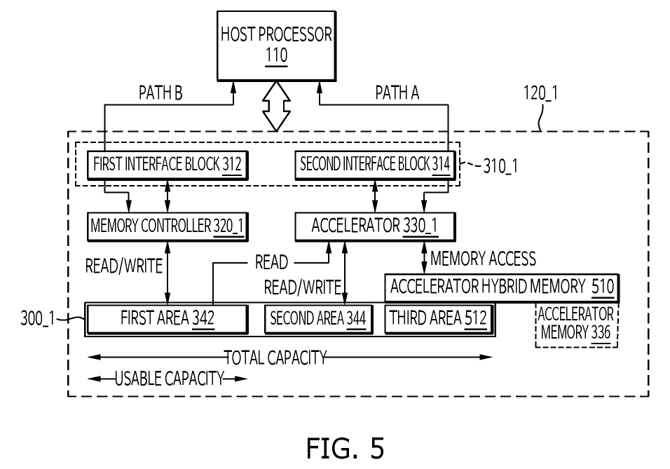

Each of the plurality of computational storage devices 120_1 to 120_n may generate an output for a request received from the host processor 110. For example, each of the plurality of computational storage devices 120_1 to 120_n may read data stored in each of the plurality of computational storage devices 120_1 to 120_n in response to a read request received from the host processor. In addition, each of the plurality of computational storage devices 120_1 to 120_n may store data in each of the plurality of computational storage devices 120_1 to 120_n in response to a write request received from the host processor. An example where each of the plurality of computational storage devices 120_1 to 120_n operates in response to requests received from the host processor 110 will be described in detail below with reference to FIG. 5.

FIG. 1. illustrates one host device 105, but the present disclosure is not limited thereto. For example, the host device 105 may include a plurality of host devices corresponding to the plurality of computational storage devices 120_1 to 120_n.

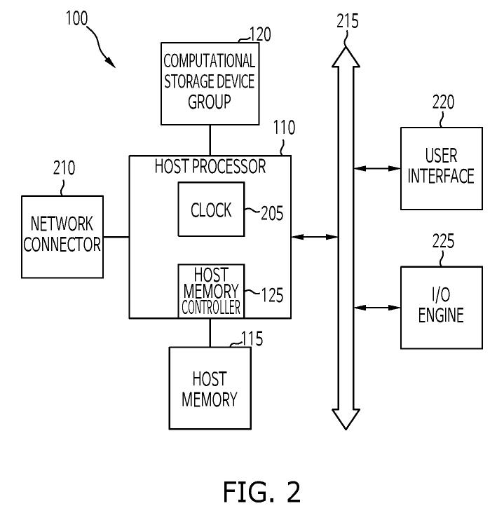

FIG. 2 is a view illustrated to explain details of a host processor 110 of a computational storage system 100 according to embodiments of the present disclosure. As illustrated, the computational storage system 100 may include a host processor 110. The host processor 110 may control the overall operation of the computational storage system 100.

The host processor 110 may include a host memory controller 125 and a clock 205. The host memory controller 125 may manage data transmission between the host processor 110 and the host memory 115. The clock 205 may synchronize the operations of the host processor 110 and the host memory 115.

The host processor 110 may be connected to host memory 115. The host memory 115 may be a volatile memory, a non-volatile memory, or a combination thereof. For example, the host memory 115 may include a volatile memory such as dynamic random-access memory (DRAM), static random-access memory (SRAM), and/or a non-volatile memory such as electrically erasable programmable read-only memory (EEPROM), ferroelectric random-access memory (FRAM), phase-change random-access memory (PRAM), magneto-resistive random-access memory (MRAM), flash memory, etc.

The host processor 110 may be connected to a computational storage device group 120. The host processor 110 may transmit and receive data to and from the computational storage device group 120. For example, the host processor 110 may transmit a request to allow a plurality of computational storage devices (e.g., 120_1 to 120_n in FIG. 1) in the computational storage device group 120 to perform a specific operation to the computational storage device group 120. In response to receiving a request from the host processor 110, a plurality of computational storage devices in the computational storage device group 120 may perform operations related to the request and return data generated by performing the operations to the host processor 110 as a response to the request.

The host processor 110 may be connected to a network connector 210. The host processor 110 may access an external network through the network connector 210. The network connector 210 may be implemented as an Ethernet connector, a wireless connector, etc., but the present disclosure is not limited thereto.

The host processor 110 may be connected to a user interface 220 and an input and output engine 225 through a bus 215. The host processor 110 may receive input data from the user interface 220 through the bus 215, and generate output data for the received input data on the user interface 220. For example, the host processor 110 may receive a user query from the user interface 220. For example, the host processor 110 may receive a user query in text form. According to embodiments, the user query may be in the form of question, or request for a specific operation or information, but the present disclosure is not limited thereto.

Each of the plurality of computational storage devices in the computational storage device group 120 may load a language model, and analyze a user query by using the loaded language model (e.g., LLM) to generate a response corresponding to the user query. Each of the plurality of computational storage devices may transmit a generated response to the host processor 110, and the host processor 110 may output the response through the user interface 220.

The host processor 110, based on a user query, may control the computational storage device 120 to extract a context or a subset related to the user query from a corpus stored in an external database and/or the computational storage device 120, and input the extracted context, subset, and the user query into the language model as a prompt. The host processor 110 may generate a response of the language model by using not only a user query but also external information related to the user query, thereby enhancing the quality of the response of the language model, and reducing the hallucination of the language model.

The input and output engine 225 may support a process of data being input or output through the bus 215. For example, the input and output engine 225 may reduce the overhead and bottleneck of the host processor 110 that may occur when the host processor 110 directly controls data input and output operations.

FIG. 3 is a view illustrated to explain an internal configuration of a computational storage device 120_1 according to embodiments of the present disclosure. The computational storage device 120_1 illustrated in FIG. 3 may be any one of a plurality of computational storage devices 120_1 to 120_n. The internal configuration of the computational storage device 120_1 will be described below with reference to FIG. 3, but the example illustrated and described with reference to FIG. 3 will be applied to each of a plurality of computational storage devices connected to a host device (e.g., 105 of FIG. 1) in the same manner.

As illustrated, the computational storage device 120_1 may include a host interface 310_1, a memory controller 320_1, a hardware accelerator 330_1 (referred to as an ‘accelerator’), and a memory array 300_1.

The host interface 310_1 may connect a host processor (e.g., 110 of FIG. 1) to the memory controller 320_1. The host interface 310_1 may connect the host processor to an accelerator 330_1. For example, the host interface 310_1 may include a first interface block and a second interface block, the host processor may be connected to the memory controller 320_1 through the first interface block, and the host processor may be connected to the accelerator 330_1 through the second interface block. The above description will be detailed below with reference to FIG. 5. The host interface 310_1 may transmit a request received from the host processor to the memory controller 320_1 and the accelerator 330_1.

The memory controller 320_1 and the accelerator 330_1 may access a memory array 300_1. For example, each of the memory controller 320_1 and the accelerator 330_1 may perform a read operation and/or a write operation for the memory array 300_1 based on a request received from the host processor, thereby transmitting or receiving data from or to the memory array 300_1. The memory controller 320_1 and the accelerator 330_1 each may perform requests from the host processor for different areas of the memory array 300_1. In addition, the memory controller 320_1 may be limited to access a specific area of the memory array 300_1. A specific example thereof will be described in detail below with reference to FIG. 5.

The memory array 300_1 may include a non-volatile memory. For example, the memory array 300_1 may include a NAND flash memory, and may be implemented in various forms such as a 2D NAND memory array, a Vertical NAND (VNAND) memory array, etc. However, the type of memory included in the memory array 300_1 is not limited thereto, and may include various non-volatile memories such as an electrically erasable programmable read-only memory (EEPROM), a ferroelectric random-access memory (FRAM), a phase-change random-access memory (PRAM), and a magneto-resistive random-access memory (MRAM).

The memory array 300_1 may include a plurality of flash chips 345_1 to 345_8. Each of the plurality of flash chips 345_1 to 345_8 may be implemented as an arbitrary memory unit that operates according to an individual request of the memory controller 320_1. In FIG. 3, the memory array 300_1 is illustrated as being implemented as the plurality of flash chips 345_1 to 345_8, but is not limited thereto, and may be implemented in various forms such as dies or packages.

Each of the plurality of flash chips 345_1 to 345_8 may be connected to any one of a plurality of channels 340_1 to 340_4. For example, each of the flash chips 345_1 and 345_2 may be connected to a first channel 340_1, and each of the flash chips 345_3 and 345_4 may be connected to a second channel 340_2. In FIG. 3, the memory array 300_1 is illustrated as including eight flash chips 345_1 to 345_8 connected through four channels 340_1 to 340_4, but is not limited thereto, and the memory array 300_1 may include any number of flash memory chips connected through any number of channels.

Each of the memory controller 320_1 and the accelerator 330_1 may transmit and receive data to and from the memory array 300_1 through the plurality of channels 340_1 to 340_4. For example, the memory controller 320_1 may transmit data to or receive data from the memory array 300_1 through at least part of the plurality of channels 340_1 to 340_4. Similarly, the accelerator 330_1 may transmit data to and receive data from the memory array 300_1 through at least part of the plurality of channels 340_1 to 340_4.

Each of the memory controller 320_1 and the accelerator 330_1 may transmit and receive data in parallel with the memory array 300_1 through a plurality of channels. For example, the memory controller 320_1 may transmit and receive data through a first channel 340_1 and the second channel 340_2 simultaneously. According to another example, the accelerator 330_1 may transmit and receive data through a third channel 340_3 and a fourth channel 340_4 simultaneously. According to yet another example, the memory controller 320_1 may transmit and receive data through the first channel 340_1 and the accelerator 330_1 may transmit and receive data through the second channel 340_2 simultaneously.

The host interface 310_1, the memory controller 320_1, the accelerator 330_1, and the memory array 300_1 may be connected to one another through a bus 350 to communicate with each other. A protocol used for communication of the bus 350 may be different from a protocol used for communication between the host device (e.g., 105 of FIG. 1) and the computational storage device 120. For example, the average communication speed according to the protocol used for communication of the bus 350 may be greater than the average communication speed according to the protocol used for communication between the host device and the computational storage device 120.

As a specific example, the memory controller 320_1, the accelerator 330_1, and the memory array 300_1 may communicate with one another based on the Advanced eXtensible Interface (AXI) protocol, and the host device and the computational storage device 120 may communicate with each other based on the PCIe protocol.

FIG. 4 is a view illustrated to explain an internal configuration of the accelerator 330_1 of FIG. 3. The accelerator 330_1 may refer to a hardware accelerator. The accelerator 330_1 may be implemented in various forms such as a graphics processing unit (GPU), a field-programmable gate array (FPGA), a tensor processing unit (TPU), an application-specific integrated circuit (ASIC), a neural processing unit (NPU), a general-purpose GPU (GPGPU), etc.

The accelerator 330_1 may include an accelerator core 332, an accelerator memory management unit 334, and an accelerator memory 336.

The accelerator core 332 may perform a computation related to a request received from a host processor (e.g., 110 of FIG. 1). For example, the host processor may request registration or execution of a program including a data flow graph (DFG). The accelerator core 332 may perform a computation on data related to a program registration request or a program execution request.

Referring to FIG. 4, the accelerator 330_1 is illustrated as including a single accelerator core 332, but the present disclosure is not limited thereto. For example, the accelerator 330_1 may include a plurality of accelerator cores, and the plurality of accelerator cores may perform operations in parallel.

The accelerator memory management unit 334 may perform a read request or write request for data required for computation based on the data flow graph. The accelerator memory 336 may store data to allow the accelerator core 332 to perform computations.

The accelerator memory management unit 334 may communicate with the memory array 300_1. The accelerator memory management unit 334 may be connected to the memory array 300_1, load data required for computation into the accelerator memory 336, or store data from the accelerator memory 336 into the memory array 300_1.

According to embodiments, the accelerator memory 336 may be a volatile memory, and the memory array 300_1 may be a non-volatile memory. As a specific example, the accelerator memory 336 may be a DRAM, and the memory array 300_1 may be a NAND flash memory, but the present disclosure is not limited thereto. The accelerator memory 336 may be used when high-speed data access is required in the accelerator 330_1, such as temporarily storing data frequently referenced during the computational process of the accelerator 330_1, or intermediate calculation results, etc., and the memory array 300_1 may be used to store a relatively large amount of data. Therefore, the performance of the computational storage system (e.g., 100 of FIG. 1) may be improved and the efficient data storage structure may be achieved by caching the data frequently used (e.g., model weights) in the accelerator 330_1 in the accelerator memory 336 and storing data that does not require real-time data processing (e.g., preprocessing data of corpus) in the memory array 300_1.

Additionally or Alternatively, the accelerator memory 336 may be a byte-addressable memory capable of reading and writing data by specifying an address in units of bytes, and the memory array 300_1 may be a page-addressable memory capable of reading or writing data in units of pages.

FIG. 5 is a view illustrated to explain an example in which a computational storage device 120_1 operates upon a request from the host processor 110. The computational storage device 120_1 illustrated in FIG. 4 may be any one of the plurality of computational storage devices 120_1 to 120_n of FIG. 1. The internal configuration and the operation of the computational storage device 120_1 will be described below with reference to FIG. 4, but may be equally applied to each of the plurality of computational storage devices connected to a host device (e.g., 105 of FIG. 1).

The computational storage device 120_1 may include a host interface 310_1, a memory controller 320_1, an accelerator 330_1, and a memory array 300_1.

The host interface 310_1 may include a first interface block 312 and a second interface block 314. The host interface 310_1 may be implemented as a circuitry, and the first interface block 312 and the second interface block 314 may be implemented as a separate circuit or an integrated circuit. According to embodiments, the first interface block 312 and the second interface block 314 each may be implemented as a different chip in the host interface 310_1. According to another embodiment, the first interface block 312 and the second interface block 314 each may be implemented through different firmware for a single chip in the host interface 310_1.

The host processor 110 may communicate with the memory controller 320_1 and the accelerator 330_1 through the host interface 310_1. For example, the host processor 110 may communicate with the memory controller 320_1 through a first interface block 312 (Path B), and communicate with the accelerator 330_1 through the second interface block 314 (Path A). The host driver (e.g., 130 of FIG. 1) that mediates the communication between the host processor 110 and the host interface 310_1 may include a driver stack to communicate with the memory controller 320_1 through the first interface block 312, and a driver stack to communicate with the accelerator 330_1 through the second interface block 314.

The first interface block 312 may transmit a request received from the host processor 110 to the memory controller 320_1. The memory controller 320_1 may access the memory array 300_1 to perform the received request. The second interface block 314 may transmit the request received from the host processor 110 to the accelerator 330_1. The accelerator 330_1 may access the memory array 300_1 to perform the request received from the host processor 110.

The memory array 300_1 may include a storage space divided into a plurality of areas 342, 344 and 512. The plurality of areas 342, 344 and 512 each may be referred to as ‘namespace’, and the data stored in each of the plurality of areas 342, 344 and 512 may be stored in the form optimized for the corresponding namespace.

The plurality of areas 342, 344 and 512 of the memory array 300_1 may include a first area 342 that allows direct access to the host processor 110, and a second area 344 that limits direct access to the host processor 110. The memory controller 320_1 may access the first area 342, but not the second area 344. However, the accelerator 330_1 may access both the first area 342 and the second area 344.

The first area 342 may be a storage space related to a usable capacity open to a host device (e.g., 105 of FIG. 1) from the total capacity of the memory array 300_1. The second area 344 may be a storage space that is not open to the host device and may refer to a storage space for performing its own computation upon a specific request received from the host processor 110.

The memory controller 320_1 may perform a first-type request of the host processor 110 received through the first interface block 312. The first-type request may be related to the first area 342 of the memory array 300_1. For example, the memory controller 320_1 may perform a read request of user data that loads user data stored in the first area 342, or perform a write request of user data that stores user data in the first area 342.

The accelerator 330_1 may perform a second-type request of the host processor 110 received through the second interface block 314. The second-type request may be related to the second area 344 of the memory array 300_1. The second-type request may be a program registration request or a program execution request for a program including a data flow graph (DFG). The accelerator 330_1 may perform a request related to the second area 344 by providing an application binary interface (ABI) related to the execution of the program.

As a specific example, the accelerator 330_1 may perform a tensor write request that stores a tensor generated during the execution of the program in the second area 344. The accelerator 330_1 may perform a tensor read request that loads a tensor required for executing the program from the second area 344. When a tensor required for executing the program is stored in the first area 342, the accelerator 330_1 may perform a tensor read request that loads the corresponding data from the first area 342. The tensor loaded from the first area 342 may be stored back in the second area 344 when needed.

The host processor 110 may determine the size of the storage space to be used by each area when the first area 342 and the second area 344 of the memory array 300_1 are defined. The host processor 110 may determine the sizes of storage spaces of the first area 342 and the second area 344 based on a ratio between the capacity of user data accessed by the memory controller 320_1 and the capacity of data used for performing computation by the accelerator 330_1.

The plurality of areas 342, 344 and 512 of the memory array 300_1 may further include a third area 512. The third area 512 may be allocated as a swap space for the accelerator 330_1. The third area 512 may be used as a backup space(or reserve space) used when the capacity of the accelerator memory 336 is out of capacity(or insufficient). The accelerator memory 336 of the accelerator 330_1 and the third area 512 of the memory array 300_1 may be implemented as an accelerator hybrid memory 510. An accelerator memory management unit (e.g., 334 of FIG. 4) of the accelerator 330_1 may access the accelerator memory 336 or the third area 512 to perform a read request or a write request for the tensor related to program execution.

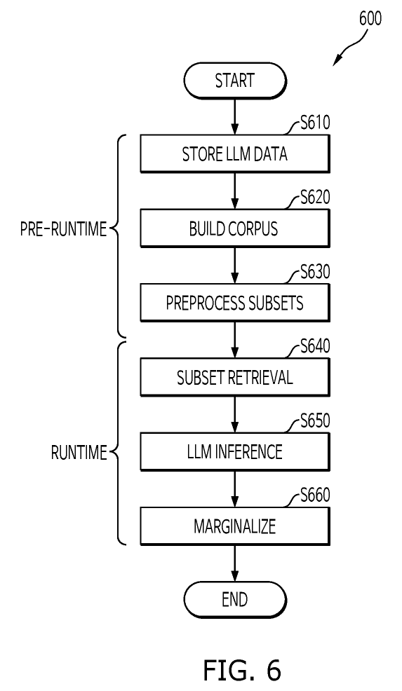

FIG. 6 is a flowchart illustrating an operation method 600 of a computational storage system according to embodiments of the present disclosure. The operation method 600 in FIG. 6 may be related to an operation method of a computational storage system for retrieval augmented generation. The operation method 600 of FIG. 6 may be performed by a computational storage system (e.g., 100 of FIG. 1) . The operation method 600 in FIG. 6 may be performed by a host device (e.g., 105 of FIG. 1) and a computational storage device (e.g., 120_1 of FIG. 1) of the computational storage system.

The computational storage system may store language model data in operation S610. For example, the computational storage system may load the language model to be executable in a given environment by storing language model data including parameters such as weights that constitute the language model, embedding data, and others. According to embodiments, the language model data may be stored in a memory array (e.g., 300_1 of FIG. 3) of each of a plurality of computational storage devices (e.g., 120_1 to 120_n of FIG. 1) and loaded into an accelerator (or, its accelerator memory) before the inference operation using the language model is initiated. The language model may be a model used in the retrieval-augmented generation (RAG).

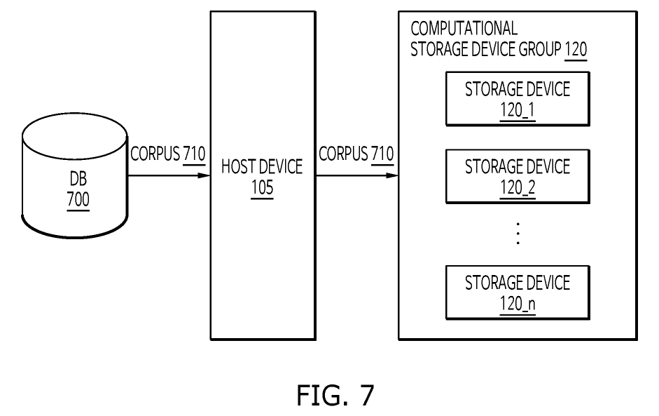

The computational storage system may establish a corpus in operation S620. The corpus may be a set of a large amount of texts of a specific language, which may include text data in various fields (e.g., medical, legal, technical fields, etc.). The computational storage system may perform web crawling, or extract data from a database that stores a corpus, thereby storing or establishing the corpus. The corpus may include a plurality of subsets. The corpus may be divided into units of subsets. The establishing process of the corpus and the subsets included in the corpus will be described in detail with reference to FIG. 7 to FIG. 15.

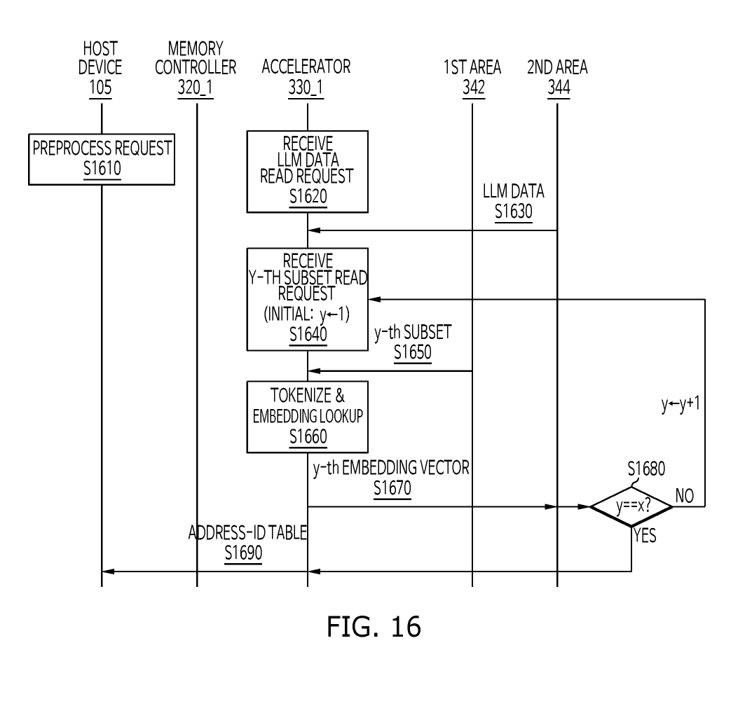

The computational storage device may preprocess subsets stored in the computational storage device in operation S630. For example, the computational storage device may preprocess the subsets by performing tokenization and embedding lookup for the subsets. The description of operation S630 will be detailed below with reference to FIG. 16 to FIG. 19.

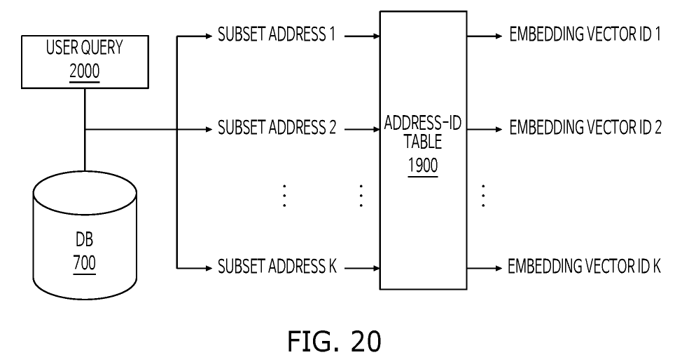

The computational storage system (e.g., a host device) may retrieve a specific subset from the corpus in operation S640. The computational storage system may receive a user query, and retrieve a subset related to the user query among a plurality of subsets included in the corpus. For example, the computational storage system may retrieve a subset similar or highly relative to the user query to generate a response to the user query and control the computational storage device to input the subset into the language model with the user query, thereby allowing the language model to generate more accurate and relevant response. The retrieved subset and the user query may be input into the language model as a prompt. The description of operation S640 will be detailed with reference to FIG. 20.

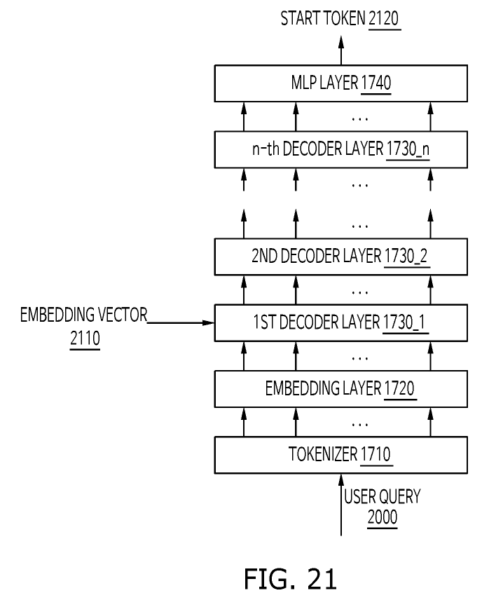

In operation S650, each of the plurality of computational storage devices may perform an inference operation based on each of the retrieved user queries and each of the subsets retrieved in operation S640. The inference operation may be an operation to output a response corresponding to the user query by using the language model loaded by each of the plurality of computational storage devices. The specific example of performing an inference operation will be detailed below with reference to FIG. 21 to FIG. 23.

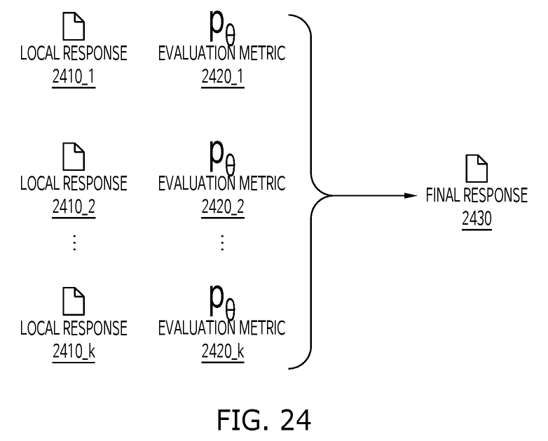

In operation S660, the computational storage system (or, a host device1) may perform a marginalization operation on the result of the inference operation performed in operation S650. For example, in operation S650, a plurality of inference operations using the plurality of computational storage devices may be performed, and a final response from the plurality of inference operations may be selected through the marginalization operation. The description thereof will be detailed below with reference to FIG. 24 to FIG. 26.

Operation S610 to Operation 630 in FIG. 6 may be performed in a pre-runtime of the retrieval augmented generation process. In operation S630, the subsets may be preprocessed in a pre-runtime, which may accelerate the inference operation on the language model in a runtime.

Operation S640 to S660 of FIG. 6 are directly related to the retrieval augmented generation process, and may be performed during the runtime.

FIG. 7 is a view illustrated to explain operation S620 of FIG. 6 in detail.

The host device 105 (or a host processor) may extract a corpus 710 from a database 700 (e.g., an external database) that stores the corpus 710. For example, the host device 105 may write a query to extract data (e.g., data satisfying specific conditions) from the database 700, transmit the query to the database 700 and receive the corpus 710 from the database 700.

The corpus 710 may include a plurality of subsets. For example, the set of the plurality of subsets may be referred to as the corpus 710. Each of the plurality of subsets may include a predetermined number of tokens (e.g., 100) or one or more paragraphs or pages, but the present disclosure is not limited thereto.

The host device 105 (e.g., a host processor), based on a plurality of subsets included in the corpus 710, may generate a plurality of embedding vectors corresponding to the plurality of subsets. The host device 105 may store the plurality of generated embedding vectors in the host memory (e.g., 115 of FIG. 1).

The host device 105 (or a host processor) may store the corpus 710 710 in a distributed manner in the plurality of computational storage devices 120_1 to 120_n in the computational storage device group 120. For example, the host device 105 may store a plurality of subsets included in the corpus 710 in a plurality of memory arrays in the plurality of computational storage devices 120_1 to 120_n in a distributed manner. Additionally or alternatively, the host device 105 (or the host processor) may store the plurality of embedding vectors generated based on the plurality of subsets in the plurality of computational storage devices 120_1 to 120_n in a distributed manner, thereby distributing and storing the corpus 710.

The host device 105 may determine the storage locations of a plurality of subsets (or, a plurality of embedding vectors) among the plurality of computational storage devices 120_1 to 120_n, i.e., a computational storage device that stores each of the plurality of subsets based on the distance between the plurality of generated embedding vectors. According to embodiments, the plurality of subsets may be stored in a first area (e.g., 342 of FIG. 5) in the memory array of each of the plurality of computational storage devices 120_1 to 120_n. The plurality of embedding vectors may be stored in a second area (e.g., 344 of FIG. 5) in the memory array of each of the plurality of computational storage devices 120_1 to 120_n.

According to embodiments, the host device 105 (or, a host processor) may apply natural language processing techniques such as tokenization, stop-word removal and stemming to subsets, and distribute and store the subsets in the plurality of computational storage devices 120_1 to 120_n.

Each of the plurality of computational storage devices 120_1 to 120_n may load the language model, and generate a response corresponding to the user query by using the loaded language model, the user query, and the subset. According to embodiments, the host device 105 may control a computational storage device that stores a subset related to the user query among the plurality of computational storage devices 120_1 to 120_n to perform an inference operation using the subset related to the user query. The inference operation may be performed in two (2) or more computational storage devices in parallel, and as the number of computational storage devices performing the inference operation in parallel increases, the performance of the computational storage system may be improved.

When the subsets retrieved to be related to the user query are stored in a single computational storage device, the inference operation may be performed only in a single computational storage device. Accordingly, the amount of parallel processing between the plurality of computational storage devices 120_1 to 120_n may decrease, thereby reducing the entire performance of the computational storage system.

Therefore, the subsets likely to be used together, i.e. the subsets with a high likelihood of being retrieved in relation to the user query may be distributed to different computational storage devices as much as possible to achieve the efficient parallel processing between the plurality of computational storage devices 120_1 to 120_n, thereby increasing the amount of parallel processing when at least part of the subsets are determined to be relevant to the user query.

The performance of the computational storage system may be considerably different depending on how to distribute the subsets into the plurality of computational storage device 120_1 to 120_n. FIG. 4 to FIG. 15 illustrate various examples for improving the performance of the plurality of computational storage systems by distributing a plurality of subsets into the plurality of computational storage device 120_1 to 120_n.

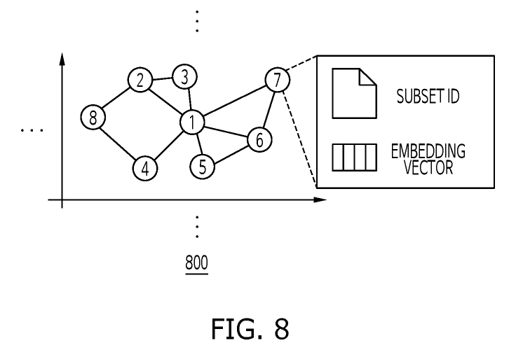

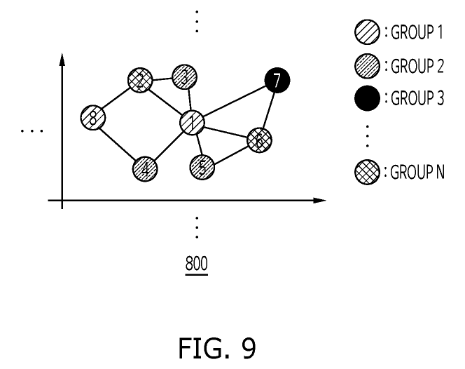

FIG. 8 is a view illustrating a plurality of embedding vectors converted from a plurality of subsets in an embedding vector space 800, FIG. 9 is a view illustrating an example of grouping a plurality of embedding vectors. In FIG. 8 and FIG. 9, the embedding vector space 800 is illustrated as being two-dimensional for ease of explanation, but the present disclosure is not limited thereto. For example, the embedding vector space 800 may be three (3) or multidimensional space according to the dimensions of the plurality of embedding vectors.

Referring to FIG. 8, each of the plurality of embedding vectors may be referred to as a node in the embedding vector space 800, and a subset identifier (subset ID) may be assigned to each node to be distinguished. For ease of explanation, the distance between the embedding vectors may be used interchangeably with the distance between nodes corresponding to embedding vectors, and the embedding vectors corresponding to respective nodes may be referred to as first to eighth embedding vectors based on numerals denoted in respective nodes, and the subsets corresponding to respective embedding vectors may be referred to as first to eighth subsets based on numerals indicated in respective nodes.

Referring to FIG. 9, the host processor (e.g., 110 of FIG. 1) may determine the storage locations of the plurality of subsets corresponding to the plurality of embedding vectors based on the distances between the plurality of embedding vectors. The host processor may transmit each of a plurality of subset groups to one of a plurality of computational storage devices based on the determined storage locations.

According to embodiments, the storage location of the subset corresponding to a specific embedding vector and the storage location of the subset corresponding to the embedding vector that is close to the corresponding embedding vector within a predetermined threshold order may be differently determined.

For example, in response to determining that the distance between each of third to fifth embedding vectors and a first embedding vector is close within a predetermined threshold order (e.g., embedding vector in top 3) among the distances between respective embedding vectors other than the first embedding vector among the plurality of embedding vectors in the embedding vector space 800 and the first embedding vector, the storage location of the first subset may be determined as a first computational storage device, the storage locations of the third to fifth subsets may be determined as a second computational storage device different from the storage location of the first subset. The storage locations of the subsets corresponding to the embedding vectors within a predetermined threshold order may be determined to be the same, and the storage location of the subset corresponding to the embedding vector which is the reference point may be different. The predetermined threshold order may be smaller than the number of the plurality of computational storage devices.

In the similar manner, in response to determining that the distance between the second embedding vector and the third embedding vector is close within a predetermined threshold order among the distances between respective embedding vectors other than a third embedding vector among the plurality of embedding vectors in the embedding vector space 800, the storage location of the second subset may be determined to as a third computational storage device different from the second computational storage device, which is the storage location of the third subset.

Additionally, even though a subset corresponds to a specific embedding vector that is close within a predetermined threshold order, when the distance to the specific embedding vector is equal to or greater than a predetermined threshold distance, the subsets may not necessarily be stored in different storage spaces.

The host processor may categorize a plurality of subsets into a plurality of subset groups (group 1 to group m, where m is a natural number greater than or equal to 2). Specifically, the host processor may categorize the subsets corresponding to a predetermined number of embedding vectors in order of distances from a reference embedding vector, among the plurality of embedding vectors, into one subset group among the plurality of subset groups, and categorize the subset corresponding to the reference embedding vector into a subset group different from the one subset group into which the subsets in the predetermined number of embedding vectors are categorized. For example, as illustrated in FIG. 9, the first subset may be categorized into the first group, and the third to fifth subsets may be categorized into the second group.

The host processor may categorize all subsets to belong to any one of subset groups by repeatedly performing the above-described process. The number of the plurality of subset groups into which the plurality of subsets are categorized may be greater than or equal to the number of the plurality of computational storage devices.

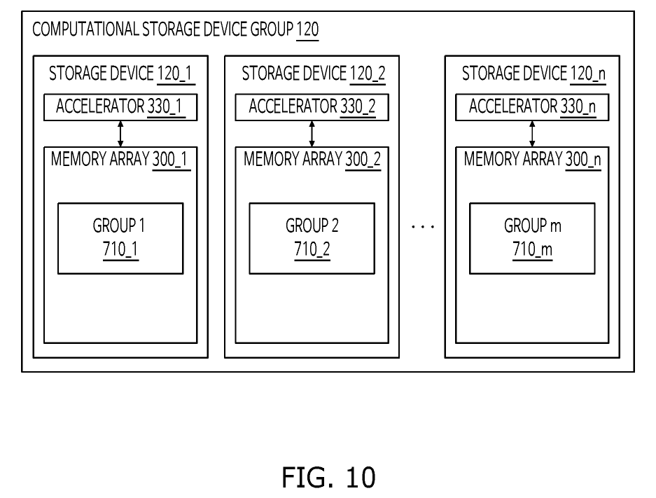

FIG. 10 is a view illustrating an example in which a plurality of subset groups 710_1 to 710_m are stored in a computational storage device group 120.

The host processor may transmit each of the plurality of subset groups 710_1 to 710_m in FIG. 9 to any one or more than one of the plurality of computational storage devices 120_1 to 120_n. The plurality of computational storage devices 120_1 to 120_n may store each of the plurality of subset groups 710_1 to 710_m received in the plurality of memory arrays 300_1 to 300_n. In addition, the plurality of computational storage devices 120_1 to 120_n may perform an inference operation by using the language model on the part of the plurality of subset groups 710_1 to 710_m stored in the plurality of memory arrays 300_1 to 300_n (where m and n are natural numbers).

When the number of the plurality of subset groups 710_1 to 710_m is smaller than or equal to the number of the plurality of computational storage devices 120_1 to 120_n (i.e., m=n or m<n), the host processor may transmit each of the plurality of subset groups 710_1 to 710_m to any one of the plurality of computational storage devices 120_1 to 120_n such that each subset group is stored in a different computational storage device.

However, when the number of the plurality of subset groups 710_1 to 710_m exceeds the number of the plurality of computational storage devices 120_1 to 120_n (i.e., m > n), the host processor may transmit each of the plurality of subset groups 710_1 to 710_m to any one of the plurality of computational storage devices 120_1 to 120_n, so that that the difference between the maximum value and the minimum value of the numbers of subset groups stored in each of the plurality of computational storage devices 120_1 to 120_n is zero (0) or one (1). That is, in an embodiment, each storage device (e.g., storage device 120_1, 120_n, etc.) will either have a same number of subset groups stored on respective storage devices, or have one or more storage devices in the computational storage group 120 that have at most one subset group more or less than the subset groups in the other storage devices in the computational storage group 120. Unlike as illustrated in FIG. 10, the memory array included in at least part of the plurality of computational storage devices 120_1 to 120_n may include the plurality of subset groups.

The host processor may categorize the embedding vectors that are close in distance to a specific embedding vector into different groups to transmit similar subsets, which are likely to be processed together, to different computational storage devices. This may increase the amount of parallel processing between the plurality of computational storage devices 120_1 to 120_n.

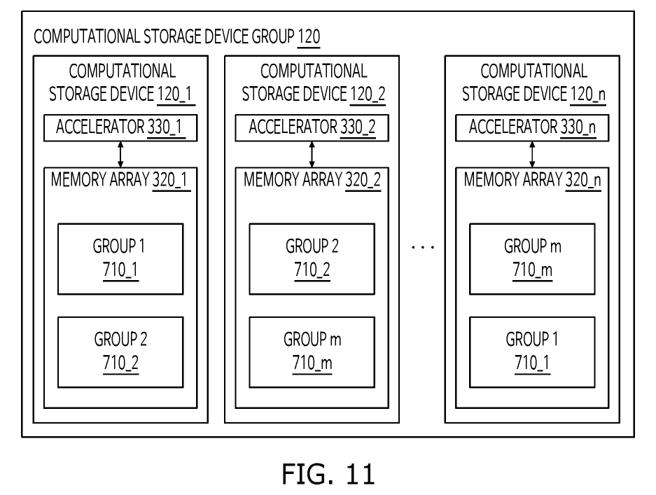

FIG. 11 is a view illustrating another example in which a plurality of subset groups 710_1 to 710_m are stored in a computational storage device group 120.

The host processor may transmit each of the plurality of subset groups 710_1 to 710_m to two (2) or more computational storage devices among the plurality of computational storage devices 120_1 to 120_n. The amount of parallel processing of the plurality of computational storage devices 120_1 to 120_n may be further increased. For example, when two (2) or more subsets categorized into a second group 710_2 are determined as the subsets associated with the user query, the subsets may be stored in each of a first memory array 320_1 and a second memory array 320_2 to be processed in parallel in the first accelerator 330_1 and the second accelerator 330_2, respectively.

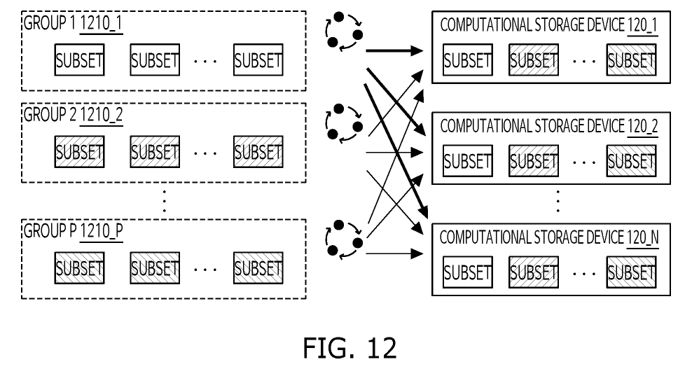

FIG. 12 is a view illustrating an example in which a plurality of subsets are stored in a plurality of computational storage devices 120_1 to 120_n according to another embodiment.

The host device 105 (or a host processor) may categorize a plurality of subsets in a corpus (e.g., 710 of FIG. 7) into a plurality of subset groups 1210_1 to 1210_p (where p is a natural number greater than or equal to 2). For example, the number of plurality of subsets included in each of the plurality of subset groups 1210_1 to 1210_p may be smaller than or equal to the number of the plurality of computational storage devices 120_1 to 120_n.

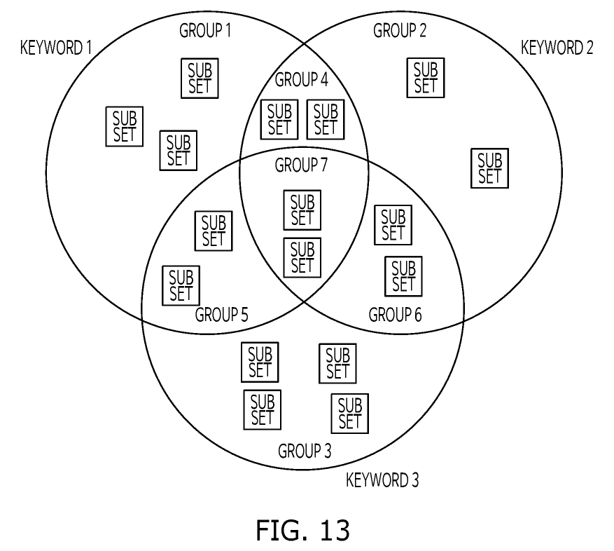

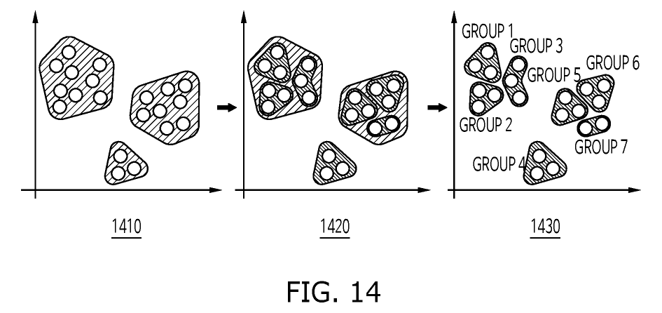

The subsets included in each of the plurality of subset groups 1210_1 to 1210_p may have high similarity to one another. For example, as the distances between embedding vectors of respective subsets decrease, the subsets may be likely categorized into the same subset group. An example of grouping the subsets with the high similarity will be described in detail with reference to FIG. 13 and FIG. 14.

The host device 105 (or a host processor) may store the subset included in each of the plurality of subset groups 1210_1 to 1210_p in each of the plurality of computational storage devices 120_1 to 120_n. When the subset included in any one of the plurality of subset groups 1210_1 to 1210_p is stored in the plurality of computational storage devices 120_1 to 120_n, the difference between the maximum value and the minimum value of the number of subsets stored in each of the plurality of computational storage devices 120_1 to 120_n may be 0 or 1. For example, a plurality of subsets in one subset group may be transmitted to the plurality of computational storage devices 120_1 to 120_n in a round-robin manner. Each of the plurality of subsets may be transmitted to any one of the plurality of computational storage devices 120_1 to 120_n so that the subsets with similarity may be stored in different computational storage devices as possible.

FIG. 13 is a view illustrating an example of grouping a plurality of subsets according to embodiments of the present disclosure.

The host device (or a host processor) may extract a plurality of keywords from a user query. For example, referring to FIG. 13, the keyword extracted from the user query may be first to third keywords (keywords 1 to 3).

The host device (or host processor) may categorize two or more subsets into the same subset group in response to each including the same number of keywords among a plurality of keywords extracted from the user query, and all keywords included in each of the two or more subsets being identical. That is, in embodiments, when two or more subsets include a same set of keywords from the extracted keywords, then they could be categorized into the same subset group. This disclosure does not limit the two or more subsets from having keywords other than the extracted keywords. For example, a subset including only a first keyword (keyword 1) may be categorized into a first group (group 1). Similarly, a subset including only a second keyword (keyword 2) may be categorized into a second group (group 2), and a subset including only a third keyword (keyword 3) may be categorized into a third group (group 3). In another example, a subset including the first keyword (keyword 1) and the second keyword (keyword 2) may be categorized into a fourth group (group 4), and a subset including the first to third keywords (keywords 1 to 3) may be categorized into a seventh group (group 7).

The subsets in the categorized subset group may be stored in the plurality of computational storage devices 120_1 to 120_n according to the embodiment illustrated and described with reference to FIG. 12.

FIG. 14 is a view illustrating an example of grouping a plurality of subsets according to another embodiment. FIG. 14 illustrates an example in which a plurality of embedding vectors (denoted by circles) marked in the embedding vector space are grouped into a plurality of clusters (denoted by shaded polygons) during first to third operations 1410 to 1430.

In a first operation 1410, a host device (or a host processor) may generate a plurality of clusters by clustering a plurality of embedding vectors based on the locations of the plurality of embedding vectors by using a clustering algorithm. Various algorithms such as k-means clustering, hierarchical clustering, density-based spatial clustering of applications with noise (DBSCAN), and spectral clustering may be used as the clustering algorithm, and the present disclosure is not limited thereto.

The host device (or a host processor) may categorize at least one or more subsets corresponding to at least one or more embedding vectors included in each of the plurality of generated clusters into any one of the plurality of subset groups.

However, in response to the number of embedding vectors included in a specific cluster among the plurality of clusters generated in the first operation 1410 exceeding a predetermined number, the host device (or, a host processor) may generate a plurality of sub-clusters by using a clustering algorithm for the embedding vector included in a specific cluster in a second operation 1420. The clustering algorithm used in the second operation 1420 may be the same as or different from the clustering algorithm used in the first operation 1410.

The second operation 1420 may be recursively repeatedly performed until when the number of embedding vectors included in each of the plurality of clusters or the plurality of sub-clusters is equal to or smaller than a predetermined number.

In a third operation 1430, a plurality of embedding vectors may be categorized into any one of a plurality of subset groups(e.g., Group 1 to 7), and a plurality of subsets corresponding to a plurality of embedding vectors may be categorized into any one of the plurality of subset groups.

The subsets in the categorized subset group may be stored in the plurality of computational storage devices 120_1 to 120_n according to the embodiment illustrated with reference to FIG. 12.

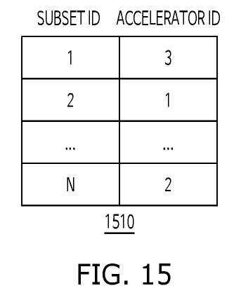

FIG. 15 is a view illustrating an example of a table 1510 related to the storage location of each of a plurality of subsets. After a plurality of subsets are stored in a plurality of computational storage devices (e.g., 120_1 to 120_n of FIG. 1), information on the storage location of each of the plurality of subsets may be stored. The information on the storage location of each of the plurality of subsets may be stored in a host memory (115 of FIG. 1) connected to a host processor (e.g., 110 of FIG. 1).

The host processor may determine a subset related to a user query, and refer to information on the storage location of each of the plurality of subsets of the table to determine a computational storage device that stores the subset related to the user query. The host processor may transmit the user query to each of the determined computational storage devices. Accordingly, the computational storage device may perform an inference operation of the language model using the user query and the subset associated with the user query in response to the host processor determining that the subset stored in the corresponding computational storage device is the subset associated with the user query.

FIG. 16 is a flowchart illustrated to explain operation S630 of FIG. 6 in detail.

FIG. 16 describes an operation between a host device 105 and one of the plurality of computational storage devices 120_1 to 120_n of FIG. 1 (e.g., 120_1 of FIG. 1), but the example illustrated and described with reference to FIG. 16 may be equally applied to each of the plurality of computational storage devices connected to the host device 105.

The host device 105 may request preprocessing of a plurality of subsets stored in a computational storage device (e.g., 120_1 of FIG. 1) in operation S1610. The plurality of subsets stored in the computational storage device may be subsets stored according to the embodiments described with reference to FIG. 7 to FIG. 14.

The host device 105 may request preprocessing of the plurality of subsets by requesting execution of a subset preprocessing program. In response to the host device 105 requesting execution of the subset preprocessing program, the subset preprocessing program may be executed, and a request to read language model data (e.g., tokenizer data and embedding layer data of the language model) of the subset preprocessing program may be transmitted to the accelerator 330_1.

The accelerator 330_1 may receive a request to read the language model data (e.g., tokenizer data and embedding layer data of the language model) in operation S1620. In response to receiving the request to read the language model data (e.g., tokenizer data and embedding layer data of the language model), the accelerator 330_1 may read the language model data (e.g., tokenizer data and embedding layer data of the language model) from a memory array in operation S1630. The accelerator 330_1 may load the language model (e.g., tokenizer and embedding layer of the language model) into the accelerator 330_1 (or an accelerator memory) by reading the language model data (e.g., tokenizer data and embedding layer data of the language model) from a memory array (e.g., second area 344).

The accelerator 330_1 (or an accelerator memory) may receive a first subset read request of the subset preprocessing program in operation S1640, and in response to receiving the first subset read request, read a first subset from the memory array in operation S1650. The first subset may be read from the first area 342 of the memory array.

The accelerator 330_1 may perform tokenization and embedding lookup operations for the first subset in operation S1660. The accelerator 330_1 may generate a first embedding vector corresponding to the first subset by performing the tokenization and embedding lookup operation on the first subset and write the first embedding vector in the memory array in operation S1670. For example, the accelerator 330_1 may generate an embedding vector corresponding to the first subset by inputting the first subset into the language model loaded into the accelerator 330_1 (or inputting the first subset into a tokenizer of the language model and then through an embedding layer). The description thereof will be detailed with reference to FIG. 11. The accelerator 330_1 may record the generated first embedding vector in the second area 344 of the memory array.

Operations S1640 to S1670 may be repeatedly performed until tokenization and embedding lookup operation are performed on all or part of the subsets stored in the memory array. For example, the accelerator 330_1 may receive a request to read a yth subset in operation S1640 (where y is a natural number greater than or equal to 2), read the yth subset from the first area 342 of the memory array in response to receiving the request to read the yth subset, and perform tokenization and embedding lookup operation on the read yth subset to generate a yth embedding vector and write the yth embedding vector in the second area 344 of the memory array. When the yth subset is not the last subset stored in the computational storage device (e.g., an xth subset, where x is a natural number greater than or equal to y) in operation S1680, the same or similar process may be repeated for the next subset. Therefore, tokenization and embedding lookup operation may be performed on a plurality of subsets (e.g., a subset in FIG. 7) stored in the first area 342 of the memory array.

The accelerator 330_1 may read the plurality of subsets from the memory array, and input the plurality of subsets into the language model loaded into the accelerator 330_1 (or inputting the plurality of subsets to a tokenizer of the language model and through an embedding layer) to generate a plurality of embedding vectors corresponding to the plurality of subsets, and write the plurality of generated embedding vectors in the memory array. The accelerator 330_1 may read the plurality of subsets from the first area 342 of the memory array, and write the plurality of embedding vectors generated from the plurality of subsets in the second area 344 of the memory array.

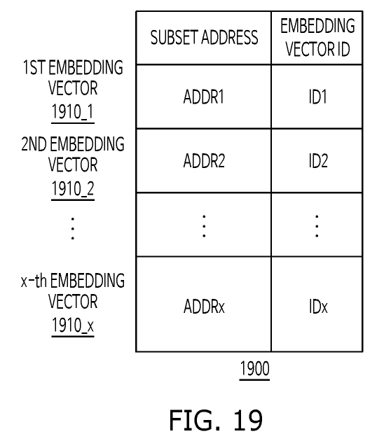

In response to tokenization and embedding lookup operation performed on all of part of the subsets stored in the first area 342, the accelerator 330_1 may store a relationship table indicating a plurality of identifiers of the plurality of embedding vectors generated from the plurality of subsets through the plurality of tokenizations and embedding lookup operations and a plurality of addresses of the plurality of subsets, and the convert the relationship table to the host device 105 in operation S1690. The relationship table will be described in detail with reference to FIG. 19.

The operation of the accelerator 330_1 in FIG. 16 may be performed by a core of an accelerator (e.g., 332 of FIG. 4) and/or a memory management unit (e.g., 334 of FIG. 4), and the language model data (e.g., tokenizer data and embedding layer data of the language model), the subsets, etc. may be stored in an accelerator memory (e.g., 336 of FIG. 4).

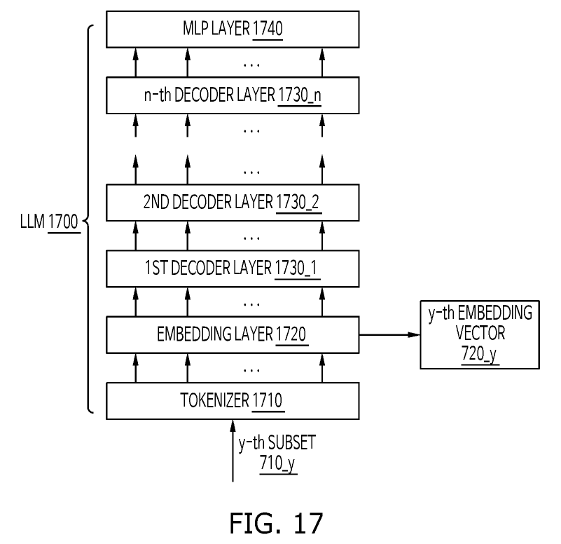

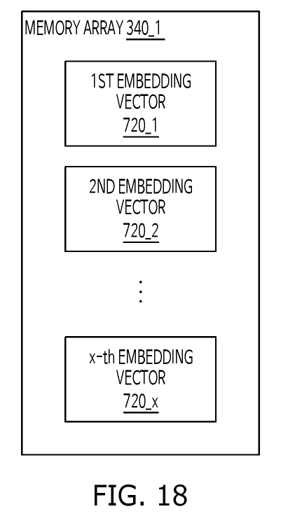

FIG. 17 is a view illustrated to explain a tokenization and an embedding lookup operation in operation S1660 of FIG. 16, and FIG. 18 is a view illustrating a plurality of embedding vectors 720_1 to 720_x generated according to a plurality of tokenizations and a plurality of embedding lookup operations.

Referring to FIG. 16 and FIG. 17, a language model 1700 illustrated in FIG. 17 may be the language model loaded to the accelerator 330_1.

The language model 1700 may include a tokenizer 1710, an embedding layer 1720, a plurality of decoder layers 720_1 to 720_x (where n is natural number equal to or greater than 2) a multi-layer perceptron (MLP) layer 1740. However, the present disclosure is not limited thereto, but part of the layers may be added to the language model 1700, or part of layers (e.g., a tokenizer) may be excluded from the language model 1700.

The tokenizer 1710 may tokenize the input text, and output the tokenized text. The tokenizer 1710 may be implemented to user various tokenization techniques to convert the input text to be processed on a different layer of the language model 1700. For example, the tokenizer 1710 may output the tokenized text by using various tokenization techniques such as word-based tokenization that divides words by blanks, subword-based tokenization (byte pair encoding, BFE) that divide words into smaller units, or character-based tokenization that divides words according to specific symbols or rules.

The embedding layer 1720 may output an embedding vector based on the tokenized text from the tokenizer 1710. The embedding layer 1720 may be implemented to use various embedding techniques for outputting the embedding vectors. For example, the embedding layer 1720 may use techniques such as one-hot encoding, Word2Vec, GloVe, FastText, etc. as word embedding techniques.

A plurality of decoder layers 1730_1 to 1730_n may receive an embedding vector generated through an embedding layer 1720, receive and process the output from the previous layer, and transmit the output to the next layer. For example, a plurality of decoder layers 1730_1 to 1730_n (where n is a natural number equal to or more than 2) may be trained on more complicated patterns based on the output from the previous layer. An attention mechanism that assigns weights to each token of an input sequence to focus on important information, particularly, a self-attention that allows each token to learn the relationship with each other, and/or a multi-head attention that allows to learn various perspectives on different parts of the input through multiple attention heads may be used.

An MLP layer 1740 may receive the output of a final decoder layer 1730_n and output a response corresponding to the text. For example, the MLP layer 1740 may be used to drive a conclusion or generate new information based on the information extracted from the plurality of decoder layers 1730_1 to 1730_n.

Referring to FIG. 16 and FIG. 17, the accelerator 330_1 may tokenize an yth subset 710_y (y is a natural number greater than or equal to 1) by the tokenizer 171 in the tokenization and embedding lookup operation of operation S1660, and convert the yth subset tokenized by the embedding layer 1720 into a yth embedding vector 720_y.

Referring to FIG. 16 and FIG. 18, as operations S1640 to S1670 are repeatedly performed, a plurality of embedding vectors 720_1 to 720_x (x is a natural number greater than or equal to 2) may be generated, and the plurality of generated embedding vectors 720_1 to 720_x may be stored in the memory array 300_1 .

FIG. 19 is a view illustrated to explain a relationship table 1900 indicating a relationship between an address and an identifier in operation S1690 of FIG. 16.

The relationship table 1900 may indicate a correspondence relationship between a plurality of addresses ADDR1 to ADDRx of a plurality of subsets and a plurality of identifiers ID1 to IDx for a plurality of embedding vectors 1910_1 to 1910_x generated from the plurality of subsets (x may be a natural number). The plurality of embedding vectors 1910_1 to 1910_x may be generated for each subset by the host device, which may be embedding vectors generated using a contextual embedding technique such as bidirectional encoder representations from transformers (BERT).

The plurality of addresses ADDR1 to ADDRx may be addresses of a plurality of subsets in a database (e.g., 700 of FIG. 7) that stores a plurality of subsets, or addresses of the plurality of subsets stored in a memory array (e.g., 342 of FIG. 16).

An identifier of an embedding vector generated from the subset through the address of a specific subset may be obtained by using the relationship table 1900.

Referring to FIG. 16 and FIG. 19, the accelerator 330_1, in response to generating a specific embedding vector, may renew the relationship table 1900 to add the identifier of the embedding vector and the address of the subset on which the embedding vector is based to the relationship table 1900.

FIG. 20 is a view illustrated to explain operation S640 in FIG. 6 in detail.

The operation illustrated and described with reference to FIG. 20 may be performed by a host device (e.g., 105 of FIG. 1), particularly, a host processor (e.g., 110 of FIG. 1) in the host device.

The host processor may obtain at least one subset address (subset addresses 1 to k, where k is a natural number equal to or greater than 1) associated with a user query 2000 from a corpus in the database 700. For example, the host processor may determine a predetermined number of subsets in order of high similarity (e.g., cosine similarity, etc.) between the embedding vector of the user query and the embedding vector of the subset or in order of short distance (e.g., Euclidean distance, Manhattan distance, etc.), to obtain the addresses of the corresponding subset. According to another example, the host processor may determine a predetermined number of subsets in order of high relevance to the user query by using an approximate nearest neighbor algorithm to obtain the addresses of the corresponding subset.

According to embodiments, the host processor may calculate the distance between the embedding vector of the user query and each of a plurality of embedding vectors of a plurality of subsets, and determine a subset corresponding to an embedding vector of which distance from the embedding vector of the user query is close within a predetermined threshold order, among the plurality of embedding vectors of the plurality of subsets, as a subset associated with the user query. The predetermined threshold order may be a multiple of the number of the plurality of computational storage devices in the computational storage system. A plurality of inference operations using the plurality of embedding vectors and the user query may be performed with high parallelism in the plurality of computational storage devices.

The number of subsets associated with the user query may be determined based on various elements. For example, the number of subsets associated the user query may be determined in consideration of a response generation time, and a response accuracy required for the language model. For example, as the language model is required to generate a response with high accuracy, the number of subsets associated with the user query may increase, and as the language model is required to generate a response with high speed, the number of subsets associated with the user query may decrease.

The host processor may obtain the identifier of at least one or more embedding vectors (embedding vectors ID 1 to k) corresponding to at least one or more subset addresses (subset addresses 1 to k) based on the relationship table 1900 described with reference to FIG. 19.

The host processor may transmit each of at least one or more embedding vectors (embedding vectors ID 1 to k) to any one of a plurality of computational storage devices (e.g., 120_1 to 120_n of FIG. 1). The host processor may transmit an identifier of an embedding vector to a computational storage device that stores a subset corresponding to an embedding vector.

The computational storage device (or, a hardware accelerator in a computational device) may read an embedding vector corresponding to the identifier of any one of the at least one or more embedding vectors (embedding vectors ID 1 to k) in response to receiving the identifier of any one of the at least one or more embedding vectors (embedding vectors ID 1 to k).

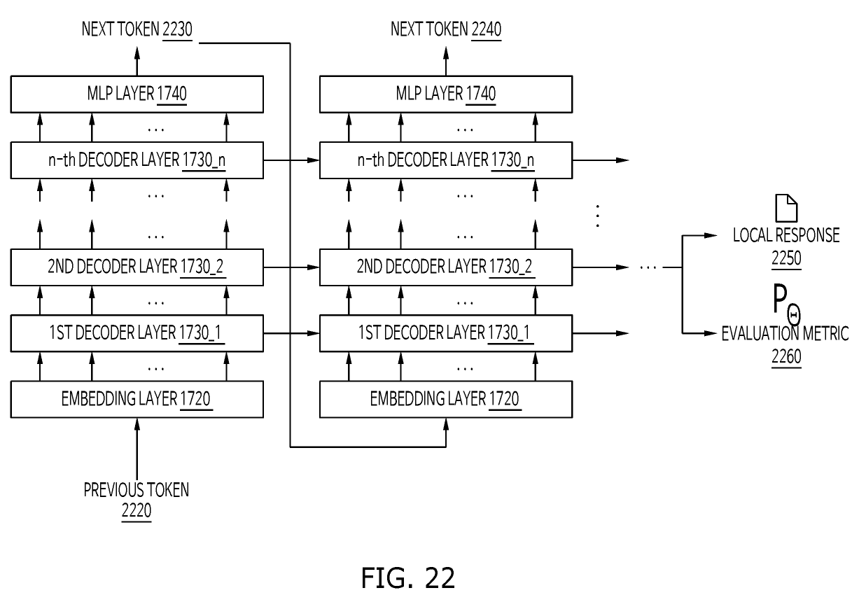

FIG. 21 and FIG. 22 are views illustrated to explain operation S650 of FIG. 6 in detail. The operation illustrated and described with reference to FIG. 21 and FIG. 22 may be performed by an accelerator (e.g., 330_1 of FIG. 3) ) (or an accelerator core in an accelerator). The operation illustrated and described with reference to FIG. 21 and FIG. 22 may be performed in each of the computational storage devices determined to store a subset or an embedding vector related to a user query 2000.

Referring to FIG. 21, the accelerator may tokenize the user query 2000 by a tokenizer 1710. The accelerator may convert the tokenized user query into an embedding vector by the embedding layer 1720.

The accelerator may input an embedding vector 2110 converted from a subset, and an embedding vector converted from the user query 2000 to a first decoder layer 1730_1 connected to an embedding layer among a plurality of decoder layers 1730_1 to 1730_n. The accelerator may output a start token 2120 corresponding to the user query 2000 based on the embedding vector 2110 converted from the subset and the embedding vector converted from the user query 2000 by the plurality of decoder layers 1730_1 to 1730_n and an MLP layer 1740. The start token may be generated in the same or similar manner that a specific subset and the user query 2000 is input into the language model as a prompt.

The accelerator may generate a next token from the start token 2120 by inputting the start token 2120 of a response back into the embedding layer 1720.

An embedding vector 2110 converted from a subset may be an embedding vector converted from a subset related to a user query, for example, an embedding vector read from a memory array by using any one of the identifiers of the embedding vectors (embedding vectors ID 1 to k) of FIG. 20. The embedding conversion on the subset for the retrieval augmented generation may not be performed in an inference operation, but the embedding vector converted from the subset before the inference operation (i.e., before a runtime) may be used, thereby accelerating an inference operation such as reducing time to first token (TTFT), and effectively preventing the overhead of the accelerator.

Referring to FIG. 22, an accelerator may input a previous token 2220 generated in an MLP layer 1740 (e.g., a start token 2120 of FIG. 21) to an embedding layer 1720. The accelerator may generate a next token 2230 from the previous token 2220 by the plurality of decoder layers 1730_1 to 1730_n and the MLP layer 1740 in response to inputting the previous token 2220 into the embedding layer 1720.

In the similar manner, the accelerator may generate a next token 2240 by the plurality of decoder layers 1730_1 to 1730_n and the MLP layer 1740 in response to inputting the generated token 2230 into the embedding layer 1720. The above process may be repeatedly performed until an end token is generated by the MLP layer 1740. In response to the end token being generated, a single inference operation performed by using a single subset may be terminated.

As a single inference operation is performed, a local response 2250 corresponding to a user query, and an evaluation metric 2260 corresponding to the local response 2250 may be output. The output local response 2250 and the evaluation metric 2260 may be transmitted to a host device.

As the evaluation metric 2260, various types of metrics for evaluating the accuracy, suitability, and/or reliability of the local response 2250 may be used. For example, the evaluation metric 2260 may include various metrics such as BLEU, ROUGE, METEOR, Precision@K, and/or Recall@K.

The inference operation illustrated and described with respect to FIG. 21 and FIG. 22 may be repeatedly performed by using each of the embedding vectors converted from the subset determined to be associated with the user query. For example, the inference operation may be performed k times by using each of k embedding vectors read from using the identifiers of the embedding vectors ID 1 to k (where k is a natural number) of FIG. 20 and the user query.

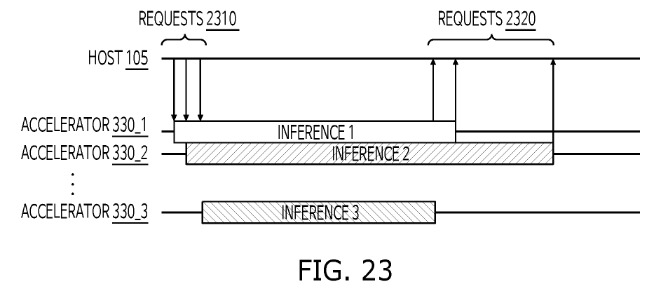

FIG. 23 is a view illustrating an example in which a plurality of inference operations are performed in parallel in a plurality of accelerators 330_1 to 330_3.

A plurality of inference operations inferences 1 to 3 may be initiated in response to the host device 105 transmitting a plurality of request 2310 to the plurality of accelerators 330_1 to 330_3. Each of the plurality of inference operations (inferences 1 to 3) may correspond to the inference operation described with reference to FIG. 21 and FIG. 22. For example, each of the plurality of inference operations (inferences 1 to 3) may be an operation that outputs a response based on a subset read from a memory array and a user query by using the language model loaded to each of the plurality of accelerators 330_1 to 330_3. Each of the plurality of inference operations (inferences 1 to 3) may be an inference operation performed by using an embedding vector converted from a single subset and a user query.

The plurality of accelerators 330_1 to 330_3 may perform at least part of any one of the plurality of inference operations (inferences 1 to 3) and at least part of another one of the plurality of inference operations (inferences 1 to 3) in parallel. For example, during a time when a first accelerator 330_1 performs a first inference operation (inference 1) that outputs a first response corresponding to a user query based on the user query and a first embedding vector, a second accelerator 330_2 may perform a second inference operation (inference 2) that outputs a second response corresponding to a user query based on a user query and a second embedding vector.

FIG. 24 is a view illustrating an example to determine a final response 2430 based on a plurality of local responses 2410_1 to 2410_k. A plurality of computational storage devices (e.g., 120_1 to 120_n in FIG. 1) may output k local responses 2410_1 to 2410_k corresponding to a user query and k evaluation metrics 2420_1 to 2420_k corresponding to the k local responses 2410_1 to 2410_k based on each of k (where k is a natural number greater than or equal to 1) embedding vectors and the user query by using the language model loaded into the accelerator.

A plurality of computational storage devices may transmit the k local responses 2410_1 to 2410_k and the k evaluation metrics 2420_1 to 2420_k to the host device (e.g., 105 in FIG. 1). A host processor (e.g., 110 in FIG. 1) of the host device 105 may determine a local response with the highest evaluation metric among the k local responses 2410_1 to 2410_k as a final response 2430. The host processor may output the determined final response 2430 to an external device (e.g., a user terminal) of the host device.

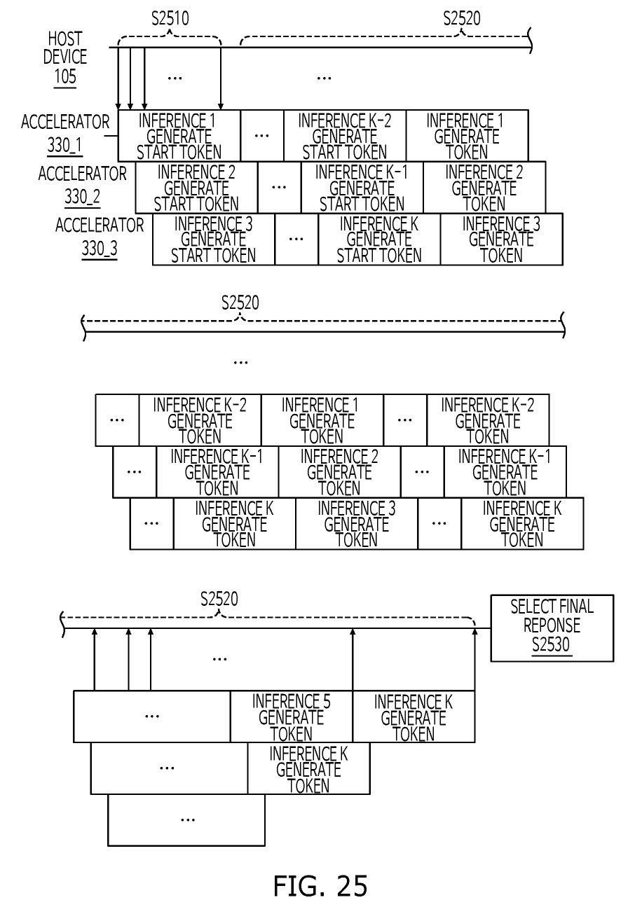

FIG. 25 is a view illustrated to explain an embodiment of operation S660 in FIG. 6.

The process in FIG. 25 may correspond to the process of determining the final response 2430 described with reference to FIG. 21, FIG. 22 and FIG. 24.

The host device 105 may transmit a plurality of requests to a plurality of accelerators 330_1 to 330_3 in operation S2510. The plurality of accelerators 330_1 to 330_3 may initiate a plurality of inference operations (inferences 1 to k, where k is a natural number equal to or greater than 2) in response to receiving the plurality of requests. The plurality of inference operations inferences 1 to k may be performed in the plurality of accelerators 330_1 to 330_3 in parallel.

The plurality of accelerators 330_1 to 330_3 may generate start tokens in parallel from the plurality of inference operations inferences 1 to k, sequentially generate the next token from the start token to generate a plurality of local responses, and transmit the plurality of generated local responses to the host device 105 in operation S2520.

The host device 105 may determine a final response from the plurality of received local responses in operation S2530.

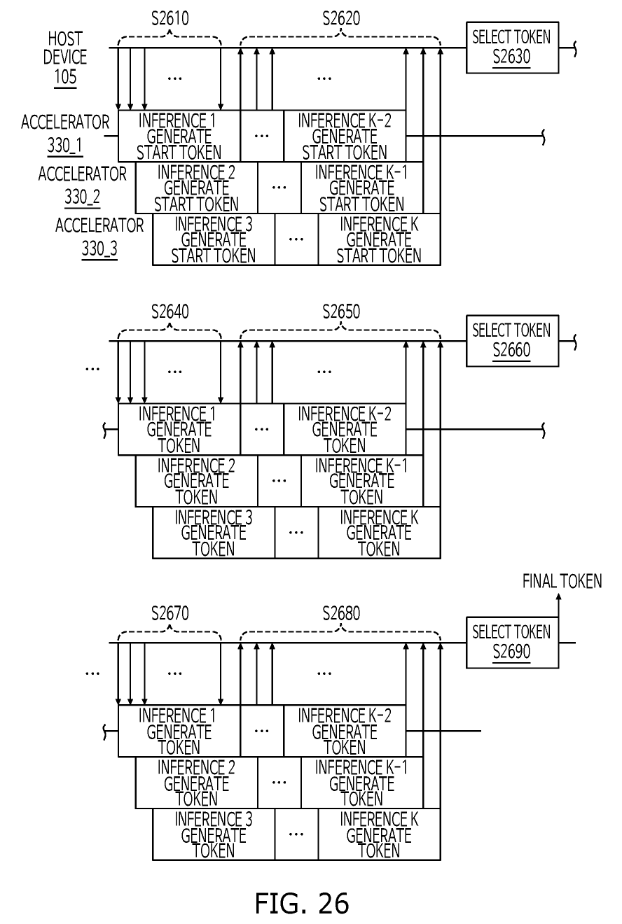

FIG. 26 is a view illustrated to explain another embodiment in operation S660 of FIG. 6.

The host device 105 (or, a host processor) may transmit a plurality of requests to the plurality of accelerators 330_1 to 330_3 in operation S2610. The plurality of accelerators 330_1 to 330_3 may initiate the plurality of inference operations (inferences 1 to k) corresponding to receiving the plurality of requests. The plurality of inference operations (inferences 1 to k) may be performed in parallel in the plurality of accelerators 330_1 to 330_3.

The plurality of accelerators 330_1 to 330_3 may output k start tokens and evaluation metrics for respective k start tokens based on k (k is a natural number greater than or equal to 1) embedding vectors and the user query by using the loaded language model and transmit the k start tokens and the evaluation metrics to the host device 105 (or a host processor) in operation S2620.

The host device 105 (or a host processor) may select a start token with the highest evaluation metric among the k start tokens in operation S2630 and transmit the start token to each of the plurality of accelerators 330_1 to 330_3 in operation S2640.

The plurality of accelerators 330_1 to 330_3 may output and transmit k next tokens and evaluation metrics for the respective k next tokens to the host device 105 based on the start token with the highest evaluation metric by using the loaded language model in operation S2650.

The host device 105 (or a host processor) may determine a next token with the highest evaluation metric as the next token from the start token with the highest evaluation metric in operation S2660.

The plurality of accelerators 330_1 to 330_3 and the host device 105 may repeat the above-described process. For example, the host device 105 may transmit the token with the highest evaluation metric to each of the plurality of accelerators 330_1 to 330_3 in operation S2670, in response, the plurality of accelerators 330_1 to 330_3 may output and transmit k tokens and k evaluation metrics to the host device 105 in operation S2680, and the host device 105 may select any one of the k tokens in operation S2690. When the token selected by the host device 105 is a final token, the final response may be determined as a set of tokens selected by the host device 105.

FIG. 23, FIG. 25, and FIG. 26 illustrate three accelerators 330_1 to 330_3 among a plurality of accelerators in a plurality of computational storage devices, but the present disclosure is not limited. A plurality of inference operations may be performed in parallel in any number of computational storage devices in which a subset associated with a user query or an embedding vector is stored.

While the present disclosure has been described with reference to exemplary embodiments thereof, but it is not limited to thereto. It will be apparent to those skilled in the art that various modifications and changes may be made within the scope of the appended claims and their equivalents without departing from the spirit and scope of the disclosure.

What is claimed is:

1. A computational storage system, comprising:
a host processor; and
a plurality of computational storage devices comprising a first computational storage device, and configured to communicate with the host processor,
wherein the host processor is configured to:
based on a plurality of subsets included in a corpus, generate a plurality of embedding vectors associated with the plurality of subsets, the plurality of subsets comprising a first subset and a second subset;
based on distances between the plurality of embedding vectors, determine respective storage locations for respective subsets from the plurality of subsets, wherein the respective storage locations are from among the plurality of the computational storage devices; and
based on the respective storage locations, transmit each of the plurality of subsets to one or more of the plurality of computational storage devices, and
wherein the first computational storage device is configured to perform a first inference operation that outputs a first response associated with a user query, based on the first subset stored in the first computational storage device and the user query.

2. The computational storage system as claimed in claim 1, wherein the plurality of embedding vectors comprise a first embedding vector corresponding to the first subset and a second embedding vector corresponding to the second subset, and
wherein the host processor is further configured to, based on a distance between the first embedding vector and the second embedding vector being within a predetermined threshold order, determine a storage location of the second subset as a second computational storage device different from a storage location of the first subset, the predetermined threshold order being from among distances between embedding vectors other than the first embedding vector and the first embedding vector.

3. The computational storage system as claimed in claim 2, wherein the predetermined threshold order is smaller than a number of the plurality of computational storage devices.

4. The computational storage system as claimed in claim 2, wherein the plurality of subsets further comprise a third subset,
wherein the plurality of embedding vectors further comprise a third embedding vector associated with the third subset, and
wherein the host processor is further configured to, based on a distance between the first embedding vector and the third embedding vector being within the predetermined threshold order, determine a storage location of the third subset as the second computational storage device different from the storage location of the first subset, the predetermined threshold order being from among the distances between embedding vectors other than the first embedding vector and the first embedding vector.

5. The computational storage system as claimed in claim 2, wherein the plurality of subsets further comprise a third subset,
wherein the plurality of embedding vectors further comprise a third embedding vector associated with the third subset, and
wherein the host processor is further configured to, based on a distance between the second embedding vector and the third embedding vector is close within the predetermined threshold order, determine a storage location of the third subset as a third computational storage device different from the storage location of the second subset, the predetermined threshold order being from among distances between embedding vectors other than the second embedding vector and the second embedding vector.

6. The computational storage system as claimed in claim 1, wherein the host processor is further configured to:
categorize the plurality of subsets into a plurality of subset groups;
categorize subsets associated with a predetermined number of embedding vectors in order of distance of one embedding vector of the plurality of embedding vectors, into one subset group of the plurality of subset groups; and
categorize a subset corresponding to the one embedding vector into another subset group different from the one subset group.

7. The computational storage system as claimed in claim 6, wherein the host processor is further configured to transmit each of the plurality of subset groups to one or more of the plurality of computational storage devices.

8. The computational storage system as claimed in claim 6, wherein a number of plurality of subset groups is equal to or greater than a number of plurality of computational storage devices.

9. The computational storage system as claimed in claim 6, wherein the host processor is further configured to transmit each of the plurality of subset groups to two or more computational storage devices from among the plurality of computational storage devices.

10. The computational storage system as claimed in claim 1, wherein the host processor is further configured to:
categorize the plurality of subsets into a plurality of subset groups; and
store a respective subset group in one or more respective computational storage device from the plurality of computational storage devices, and
wherein a difference between a maximum number of subset groups and a minimum number of subset groups stored in the plurality of computational storage devices is zero or one when subsets included in one or more of the plurality of subset groups are stored in the plurality of computational storage devices.

11. The computational storage system as claimed in claim 10, wherein the host processor is further configured to:
extract a plurality of keywords from the user query; and
based on two or more subsets from among the plurality of subsets comprising a same set of extracted keywords from the plurality of extracted keywords, categorize the two or more subsets into a same subset group.

12. The computational storage system as claimed in claim 10, wherein the host processor is further configured to:
generate a plurality of clusters by clustering the plurality of embedding vectors based on locations of the plurality of embedding vectors and a clustering algorithm; and
categorize at least one subset corresponding to at least one embedding vector included in each of the plurality of clusters into one or more of the plurality of subset groups.

13. The computational storage system as claimed in claim 12, wherein the host processor is further configured to:
based on a number of embedding vectors comprised in a specific cluster from among the plurality of clusters exceeding a predetermined number of embedding vectors, generate a plurality of subclusters for embedding vectors comprised in the specific cluster; and
categorize the at least one subset associated with the at least one embedding vector comprised in each of the plurality of subclusters into one or more of the plurality of subset groups.

14. The computational storage system as claimed in claim 1, wherein the host processor is further configured to determine a subset associated with the user query from among the plurality of subsets, the subset associated with the user query comprising the first subset, and
wherein the first computational storage device is further configured to perform the first inference operation, based on the host processor determining the first subset as the subset associated with the user query.

15. The computational storage system as claimed in claim 14, wherein the host processor is further configured to:
generate an embedding vector of the user query;
calculate distances between the embedding vector of the user query and each of the plurality of embedding vectors; and
determine a subset associated with an embedding vector that has a distance of a predetermined threshold order from the embedding vector of the user query as the subset associated with the user query, and
wherein the predetermined threshold order is a multiple of a number of plurality of computational storage devices.

16. The computational storage system as claimed in claim 1, further comprising:
a host memory connected to the host processor,
wherein the host memory is configured to store information related to a storage location of each of the plurality of subsets, and
wherein the host processor is further configured to:
determine a subset associated with the user query from among the plurality of subsets; and
transmit the user query to each computational storage device comprising the subset associated with the user query based on information on the storage location.

17. The computational storage system as claimed in claim 16, wherein the host processor is further configured to:
determine the first subset stored in the first computational storage device as the subset associated with the user query; and
transmit the user query to the first computational storage device, and
wherein the first computational storage device comprises:
a first memory array configured to store the first subset; and
a first hardware accelerator configured to obtain a language model, read the first subset from the first memory array, and perform the first inference operation that outputs the first response based on the user query and the first subset using the language model.

18. The computational storage system as claimed in claim 17, wherein the plurality of computational storage devices further comprise a second computational storage device that stores the second subset,
wherein the host processor is further configured to:
determine the second subset stored in the second computational storage device as the subset associated with the user query; and
transmit the user query to the second computational storage device,
wherein the second computational storage device comprises:
a second memory array configured to store the second subset; and
a second hardware accelerator configured to obtain the language model, read the second subset from the second memory array, and perform a second inference operation that outputs a second response based on the user query and the second subset using the language model, and
wherein at least part of the first inference operation and at least part of the second inference operation are performed in parallel.

19. A computational storage system, comprising:
a host processor; and
a plurality of computational storage devices comprising a first computational storage device and a second computational storage device, and configured to communicate with the host processor,
wherein the host processor is configured to:
generate a plurality of embedding vectors associated with the plurality of subsets based on a plurality of subsets included in a corpus;
categorize the plurality of subsets into a plurality of subset groups;
categorize subsets associated with a predetermined number of embedding vectors within a predetermined order from one embedding vector of the plurality of embedding vectors as one subset group of the plurality of subset groups;
categorize the subset corresponding to the one embedding vector into another subset group different from the one subset group;
transmit each of the plurality of subset groups to one or more of the plurality of computational storage devices; and
determine a subset associated with a user query from among the plurality of subsets,
wherein the subset associated with the user query comprises a first subset stored in the first computational storage and a second subset stored in the second computational storage,
wherein the first computational storage device is configured to perform a first inference operation that outputs a first response associated with the user query based on the user query and the first subset,
wherein the second computational storage device is configured to perform a second inference operation that outputs a second response associated with the user query based on the user query and the second subset, and
wherein at least part of the first inference operation and at least part of the second inference operation are performed in parallel.

20. A host device, comprising:
a host processor; and
a host memory connected to the host processor,
wherein the host processor is configured to:
generate a plurality of embedding vectors associated with the plurality of subsets based on a plurality of subsets included in a corpus, the plurality of subsets comprising a first subset and a second subset;
based on distances between the plurality of embedding vectors, determine respective storage locations for respective subsets from the plurality of subsets, wherein the respective storage locations are from among a plurality of computational storage devices that communicate with the host processor; and
transmit each of the plurality of subsets to one or more of the plurality of computational storage devices based on the determined storage locations.
